(19) United States
(12) Patent Application Publication
(10) Pub. No.: US 2017/0310088 A1
(43) Pub. Date: Oct. 26, 2017

(54) Spark Plug Insulator and Method of Making the Same

(71) Applicant: Federal-Mogul Ignition Company, Southfield, MI (US)

(72) Inventors: William J. Walker, JR., Ann Arbor, MI (US); Morgana L. Fall, Albany, NY (US); Holly S. Shulman, Troy, NY (US)

(21) Appl. No.: 15/490,061

(22) Filed: Apr. 18, 2017

Related U.S. Application Data
(60) Provisional application No. 62/327,484, filed on Apr. 26, 2016.

(51) Int. Cl. H01T 21/02; H01T 13/38; H05B 6/64; H05B 6/80

(52) U.S. Cl. CPC H01T 21/02; H05B 6/80; H01T 13/38; H05B 6/6482

(57) ABSTRACT

A manufacturing method, firing tray, and microwave kiln for spark plug insulators. Using microwave energy and particularly structured time-temperature profiles may allow for efficient sintering of the spark plug insulator ceramic material. The method may use a combination of radiant heat energy heating and microwave energy heating to facilitate the sintering process.

This application claims the benefit of U.S. Provisional Application No. 62/327,484, filed on Apr. 26, 2016, the contents of which are hereby incorporated by reference in their entirety.

### FIELD

The present disclosure generally relates to insulators for spark plugs and, more particularly, to alumina-based ceramic insulators and methods of making the same.

### BACKGROUND

Methods of manufacturing ceramic spark plug insulators oftentimes include a bisque firing process that heats the ceramic spark plug insulator with radiant heat energy. Bisque firing processes for ceramic spark plug insulators, which includes sintering to a high density (e.g., 97-99% of the theoretical density of the material), may take roughly 30 to 36 hours and may result in high costs due to the amount of energy needed to fire the spark plug insulators. Large tunnel kilns with radiant or convective heat sources, which are typically used to fire spark plug insulators, inefficiently consume energy. Approximately 50% of the energy is used to heat the kiln itself, including losses up the stack. Another 40% of the total energy is used to heat the firing trays that are used to support and transport the insulators through the kiln, leaving only 10% or less of the total energy for actually heating the parts. These inefficiencies can lead to excessive energy costs, longer cycle times, and low throughput.

The spark plug insulator firing process can also structurally impact the quality of the insulator. With bisque firing processes and large tunnel kilns, the firing process takes longer, not only because of the energy inefficiencies, but because of the time required for radiant heat to be transferred uniformly across a firing tray. Insulators on the outside of a firing tray are heated first and insulators toward the center of a tray take longer to heat. Having a more uniform time-temperature profile amongst insulators being fired together is desirable, as a generally uniform time-temperature profile can result in more consistent mechanical and dielectric properties among the fired insulators. Moreover, with conventional heating methods, heat is only applied to the surface of a part and thermal conduction must move that heat from the surface of the part to the interior. With microwave heating, on the other hand, heat is generated at a certain distance into the part, and there is accordingly a much shorter distance for which the heat transfer must rely upon thermal conductivity.

### SUMMARY

According to one embodiment, there is provided a method of manufacturing a spark plug. The method comprises the step of loading an unfired spark plug insulator into a kiln. The unfired spark plug insulator has a density and at least partially comprises a ceramic material. The method further comprises the step of heating the unfired spark plug insulator with radiant heat energy when the temperature of the unfired spark plug insulator is below a minimum absorption temperature. The ceramic material is at least partially transparent to microwave energy at the minimum absorption temperature. The method further comprises the step of heating the unfired spark plug insulator with microwave energy until the temperature of the unfired spark plug insulator reaches a maximum absorption temperature. The unfired spark plug insulator becomes a fired spark plug insulator upon reaching the maximum absorption temperature, the fired spark plug insulator having a density. The method further comprises the step of unloading the fired spark plug insulator from the kiln. The density of the fired spark plug insulator is higher than the density of the unfired spark plug insulator.

According to another embodiment, there is provided a method of manufacturing a spark plug. The method comprises the step of loading an unfired spark plug insulator into a kiln. The unfired spark plug insulator comprises a ceramic material that is at least partially transparent to microwave energy, and the kiln comprises a pre-heating zone, a sintering zone, and an exit zone. The method further comprises the steps of heating the unfired spark plug insulator with radiant heat energy in the pre-heating zone of the kiln, moving the unfired spark plug insulator to the sintering zone of the kiln, and heating the unfired spark plug insulator with microwave energy in the sintering zone of the kiln until the unfired spark plug insulator becomes a fired spark plug insulator. The unfired spark plug insulator has a density and the fired spark plug insulator has a density, and a ratio of the density of the unfired spark plug insulator to the density of the fired spark plug insulator is in a range of about 1:1.65 to about 1:1.92, inclusive. The method further comprises the steps of cooling the fired spark plug insulator in the exit zone of the kiln, and unloading the fired spark plug insulator from the kiln.

According to another embodiment, there is provided a spark plug insulator firing tray. The spark plug insulator firing tray comprises an exterior housing having a bottom wall and a side wall. The exterior housing is at least partially transparent to microwaves and is comprised of a low mass refractory material that is coated with a layer of ceramic material. The layer of ceramic material is denser than the low mass refractory material. The spark plug insulator firing tray further comprises a spark plug insulator support, wherein the interior spark plug insulator support is configured to maintain at least one spark plug insulator in a vertical position during a spark plug insulator firing process.

### DRAWINGS

Preferred exemplary embodiments of the invention will hereinafter be described in conjunction with the appended drawings, wherein like designations denote like elements, and wherein:

FIG. 1 is a cross-sectional view of an exemplary spark plug;

FIG. 2 is a cross-sectional view of an exemplary unfired insulator that may be used with the method disclosed herein;

FIG. 3 is a perspective view of a firing tray according to one embodiment;

FIG. 4 is a perspective view of a firing tray according to another embodiment;

FIG. 5 is a perspective view of a firing tray according to another embodiment;

FIG. 6 schematically illustrates a kiln according to one embodiment;

FIG. 7 is a flowchart illustrating different steps or stages of an exemplary method for manufacturing a spark plug insulator; and

FIGS. 8-13 are graphs showing loss tangent (tan δ) and half power depth data for various spark plug insulator compositions.

### DESCRIPTION

The method described herein may be used to manufacture a fired ceramic insulator for a spark plug using microwave energy. Fast firing is encouraged through the use of rapid, volumetric heating with microwave energy. Using microwave energy and the particular time-temperature profiles described herein during the spark plug insulator firing or sintering process can be more efficient than normal heating and cooling means, particularly with respect to alumina-based ceramic materials. In some embodiments, the frequencies of the microwaves in the electromagnetic spectrum are optimized based on the particular spark plug insulator design and/or composition. The present method involves loading a ceramic, unfired spark plug insulator into a kiln. The ceramic material, such as alumina, is at least partially transparent to microwave energy when the unfired spark plug insulator is below a minimum absorption temperature. Accordingly, radiant heat energy may be used to supplement the heating process. In one embodiment, a combination of radiant heat energy and microwave energy is applied to bring the unfired spark plug insulator to the minimum absorption temperature. Microwave energy may be used to heat the unfired spark plug insulator once the temperature of the kiln is between the minimum absorption temperature and the maximum absorption temperature. The microwave energy can continue to heat the unfired spark plug insulator until reaching the maximum absorption temperature. At the maximum absorption temperature, the unfired spark plug insulator becomes a fired spark plug insulator, which will be described in further detail below. The fired spark plug insulator may then be cooled and unloaded from the kiln. The present method and time-temperature profiles for firing spark plug insulators can be more efficient than typical firing processes and may be completed in less than 3 hours, and possibly less than 1 hour, when using a microwave-based continuous furnace.

During a microwave-based sintering process, the spark plug insulator may be moved through a kiln with a firing tray. The firing trays discussed herein may withstand extreme heat of at least 1600° C., and up to 1700° C. to properly fire the insulators, have a low thermal mass, be ultra-light weight, and at least in some embodiments, may be composed of a ceramic material with a ceramic coating. In some embodiments, the firing trays or areas of the kiln may include susceptors that absorb microwave energy and convert it to radiant heat to further assist in the spark plug insulator firing process. Although the following description is provided in the context of an automotive spark plug and process for firing, it should be appreciated that the insulator and method described herein may be used with any type of spark plug or ignition device, including glow plugs, industrial plugs, aviation igniters and/or any other device having a fired insulator used to isolate electric current. It should further be appreciated that the terms “firing,” “sintering,” and variations thereof are used interchangeably.

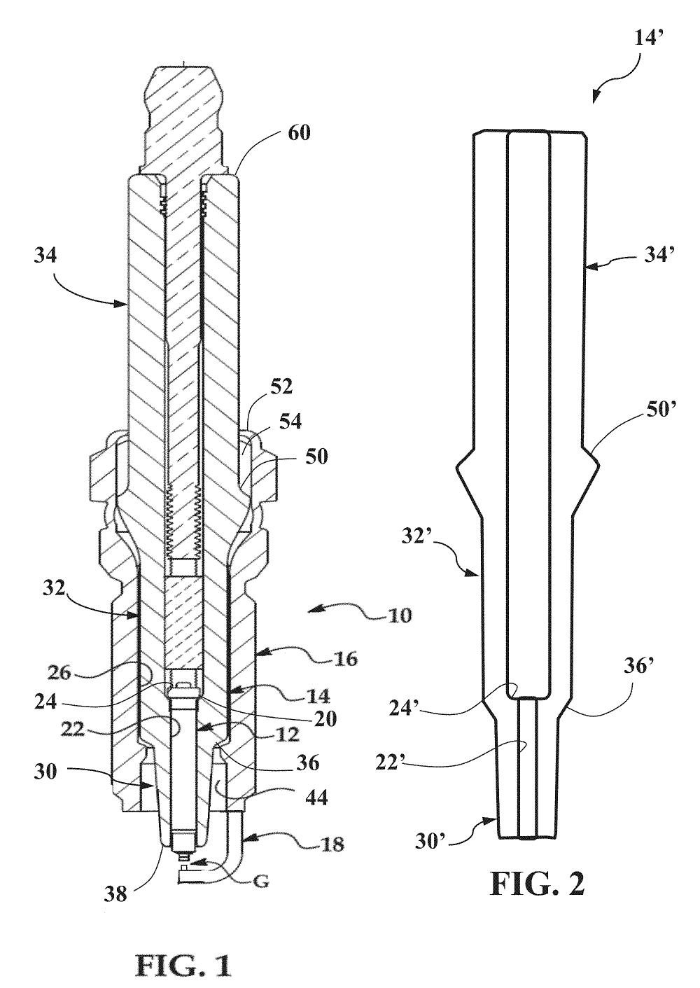

An exemplary spark plug is shown in FIG. 1, where the spark plug has a fired insulator that was at least partially sintered using microwave energy. The spark plug 10 includes a center electrode 12, a fired insulator 14, a metallic shell 16, and a ground electrode 18. The center electrode 12, which can be a single unitary component or can include a number of separate components, is at least partially disposed or located within an internal bore 22 that extends along the axial length of the fired insulator 14. As illustrated, the internal bore 22 includes one or more internal step portions 24 that circumferentially extend around the inside of the bore and are designed to receive complementary external step portions 20 of the center electrode 12. In the exemplary embodiment of FIG. 1, the internal bore 22 only includes a single internal step or shoulder portion 24; however, it is possible for the internal bore to include additional internal step portions at different axial positions along the length of the bore or may not include any internal step portions at all. The fired insulator 14 is at least partially disposed within an internal bore 26 of the metallic shell 16, and the internal bore 26 extends along the length of the metallic shell and is generally coaxial with the internal bore 22. In the particular embodiment shown, a tip end of the fired insulator 14 extends from and protrudes beyond the end of the metallic shell internal bore 26, and a tip end of the center electrode 12 extends from and protrudes beyond the insulator internal bore 22. The tip end of the center electrode 12 forms a spark gap G with a corresponding portion of the ground electrode 18. In the FIG. 1 embodiment, both the center and ground electrodes 12, 18 have precious metal firing elements attached thereto, but this is optional and is not required.

Turning now to fired insulator 14, the insulator is an elongated and generally cylindrical component that is made from an electrically insulating material and is designed to isolate the center electrode 12 from the metallic shell 16 so that high-voltage ignition pulses in the center electrode are directed to the spark gap G. The fired insulator 14 includes a nose portion 30, an intermediate portion 32, and a terminal portion 34; however, other configurations or embodiments may be implemented.

The nose portion 30 extends in the axial or longitudinal direction between an external step 36 on the outer surface of the insulator and a distal end 38 located at a tip of the insulator. The nose portion 30 may have a continuous and uniform taper along its axial extent, or it could have sections of differing taper or no taper at all (i.e., straight sections where the outer surfaces are parallel to one another). Moreover, the extent to which the nose portion 30 axially extends or protrudes beyond the end of the metallic shell 16 (sometimes referred to as the “projection”), may be greater or less than that shown in FIG. 1. In some cases, it is even possible for the distal end or tip 38 of the nose portion to be retracted within the insulator bore 22 so that it does not extend beyond metallic shell at all (i.e., a negative reach).

The intermediate portion 32 of the insulator extends in the axial direction between an external locking feature 50 and the external step 36 described above. In the particular embodiment illustrated in FIG. 1, the majority of the intermediate portion 32 is located and retained within the internal bore 26 of the metallic shell 16. The external locking feature 50 may have a diametrically-enlarged shape so that during a spark plug assembly process an open end or flange 52 of the metallic shell can be folded over or otherwise mechanically deformed in order to securely retain the fired insulator 14 in place. The folded flange 52 also traps an annular seal or gasket 54 in between an exterior surface of the insulator 14 and an interior surface of the metallic shell 16 so that a certain amount of sealing is achieved. Other intermediate portion features are certainly possible as well.

The terminal portion 34 is at the opposite end of the fired insulator 14 as the nose portion 30 and it extends in the axial direction between the external locking feature 50 and a distal end 60. In the illustrated embodiment, the terminal portion 34 is quite long; however, it may be shorter and/or have any number of other features, like annular ribs. It should be noted that the exemplary embodiment shown in FIG. 1 and described above is only meant to serve as one example of a fired insulator that is made according to the process taught herein, as that process may be used to make other insulator embodiments, including those that differ significantly from the fired insulator 14. Furthermore, spark plug 10 is not limited to the illustrated embodiment and may utilize any combination of other known spark plug components, such as terminal studs, internal resistors, internal seals, various gaskets, precious metal elements, etc., to cite a few of the possibilities.

With reference to FIG. 2, there is shown an exemplary embodiment of an unfired insulator 14′. The unfired insulator 14′ shares similar reference numerals to that of the fired insulator 14 with the exception of the added prime. It should be noted that any of the discussion herein with regard to “insulator 14” may be applicable to either the fired insulator 14 or the unfired insulator 14′ unless otherwise stated. The unfired insulator 14′ may be machined or otherwise formed prior to firing, to include features such as an insulator internal bore 22′ a single internal step or shoulder portion 24′, a nose portion 30′, an intermediate portion 32′, a terminal portion 34′, an external step 36′ and an external locking feature 50′; however, other configurations or embodiments are certainly possible. The unfired insulator 14′ becomes a fired insulator 14 once the insulator reaches the maximum absorption temperature. However, it should be understood that further sintering may occur after the insulator reaches the maximum absorption temperature or while the insulator is maintained at the maximum absorption temperature. At the maximum absorption temperature, the density of the fired insulator 14 is less than that of the unfired insulator 14′. The increase in density of a fired spark plug insulator may be at least partially attributable to bonding between ceramic particles. The increase in density is accompanied by a decrease in the size or shrinkage of the insulator during firing. Typically, the shrinkage is between 15% and 20%.

The insulator 14 may be comprised of any operable ceramic-based material, and in one embodiment, includes alumina (Al₂O₃) ceramic particles. Typically, but not necessarily, ceramic particles are mixed with a liquid medium and a binder, and may include one or more additives, such as zirconia, kaolin, talc, and/or calcium carbonate. Alumina-based ceramics in particular tend to have relatively high mechanical and dielectric strength, as well as high electrical resistivity and low dielectric loss, and are known to retain these properties over a relatively wide temperature range. Preferred ceramic particle compositions for the ceramic material comprise 90 wt % alumina, 96 wt % alumina, and 99 wt % alumina, respectively. These compositions of alumina may be more likely to absorb microwave energy at increasing temperatures for a majority of frequencies. However, other compositions are certainly possible. Preferred ceramic compositions are disclosed in U.S. Pat. No. 4,879,260 to Manning, U.S. Pat. No. 7,169,723 to Walker, Jr., and U.S. Pat. No. 8,434,443 to Lykowski, all of which are incorporated herein by reference in their entirety.

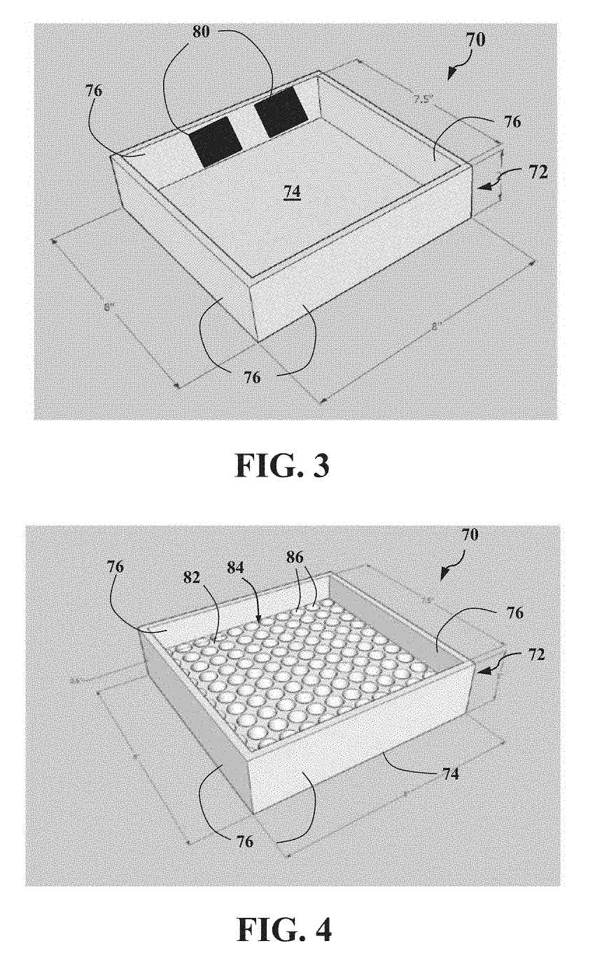

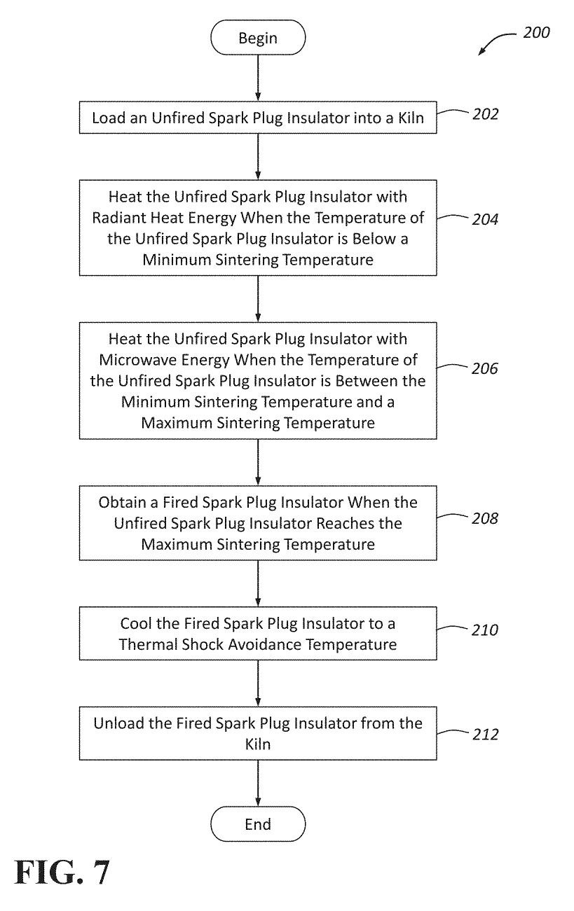

A firing tray 70 is shown in FIGS. 3-5 that may be used with a microwave-based sintering process to fire an unfired spark plug insulator, such as process 200 that is described below with respect to FIG. 7. The firing tray 70 has an exterior housing 72, which includes a bottom wall 74 and a plurality of side walls 76. As illustrated, the firing tray 70 has four side walls 76 but is not limited to four side walls and may have any structure that sufficiently holds the insulators in a desired position during the firing process. Structural modifications to the firing tray may be made depending on the type of loading method. For example, if a pick and place robot is used to load unfired spark plug insulators in the firing tray 70, the wall height, spacing between the spark plug insulators, or other parameters may be altered to coordinate maximum loading efficiency. In the illustrated embodiments, the firing tray 70 is approximately 8×8 inches in size, with a 0.25 inch wall thickness. These dimensions are merely for example purposes, and may be adjusted based on the size of the kiln, the time-temperature profiles used, or any other considerable parameter.

The thermal and dielectric properties of the firing tray 70 can also be optimized for compatibility with microwaves. For example, the exterior housing 72 may be composed of a low mass refractory material which may include any heat resistant material capable of withstanding maximum absorption temperatures. In a preferred embodiment, the firing tray 70 is made from a low mass fibrous refractory material which is coated with a layer of denser ceramic to provide strength and durability. One particular example is a firing tray made from low mass mullite and coated with mullite. Using ultra-light weight mullite firing trays can enable fast heating rates. Preferably, the firing trays have minimal interaction with the microwaves and are optimally microwave transparent. If the firing trays do not absorb microwaves, they will not be directly heated by the microwaves so that the microwave energy can be more efficiently directed to the spark plug insulators. Further, low thermal mass firing trays can be thermally insulating and help prevent the spark plug insulators from losing heat to the surroundings. In this respect, the energy efficiency of the furnace is increased because the energy is directed to primarily heating the insulators.

FIG. 3 shows a firing tray 70 which has susceptors 80. Susceptors 80 absorb microwave energy and convert it to radiant heat to further assist in the spark plug insulator firing process. More particularly, susceptors 80 may be used to help bring the spark plug insulators to the minimum absorption temperature and can supplement the heating process when the spark plug insulators are more transparent to microwave energy. Susceptors 80 may, or may not be included in any operable form, such as one or more rods or bricks, or one or more film sections disposed on the firing tray 70 as shown in FIG. 3. Instead of, or in addition to, being integrated or otherwise transported with the firing tray 70, susceptors 80 may be in fixed positions within the kiln. In particular, susceptors 80 can be used in the preheating zone of a kiln to help bring the spark plug insulators to the minimum absorption temperature or used in the preheating and exit zones of a kiln to help mitigate microwave leakage. An example susceptor material is silicon carbide.

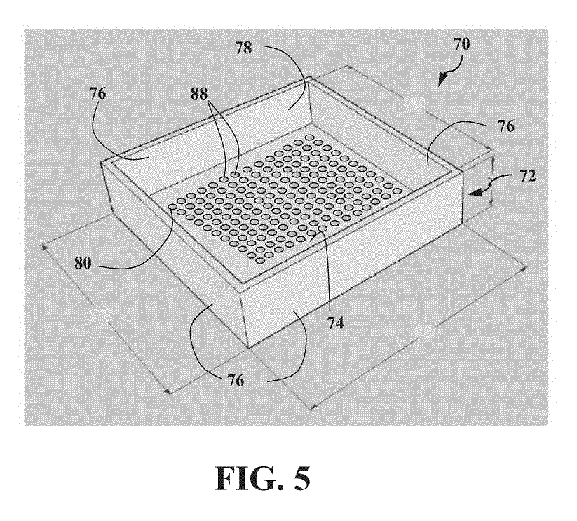

FIGS. 4 and 5 show firing trays 70 having various configurations to aid in the positioning of the spark plug insulators during a firing process. Preferably, the spark plug insulators are maintained in a vertical orientation during a firing process (i.e., with the axial length of the internal bore 22 of the insulator 14 oriented orthogonal to the bottom wall 74 of the firing tray 70). If the insulators are not in a vertical orientation, they may be subject to deformation from the force of gravity at elevated temperatures. Different features or designs may be implemented to help keep the spark plug insulators 14 in a vertical orientation, such as an insert 82, features integrally formed with or otherwise attached to the bottom wall 74, or the use of a low mass granular material, to cite a few examples.

In FIG. 4, the firing tray 70 includes an insert 82 which has a network 84 of cylindrical apertures that generally define a plurality of hollow recesses 86. The insert 82 in this embodiment is made out of plastic, which burns up early in the firing process, typically at about 500° C., but it is also possible to use another material capable of withstanding the temperatures involved in the particular sintering process. Further, the insert 82 may be made of a susceptor material or may include one or more susceptors therewith. The insert 82 includes hollow recesses 86 that are generally sized such that they can accommodate the spark plug insulators. In one embodiment, the unfired spark plug insulator 14′ has a diameter of about 0.6 inches, and if a 7.5×7.5 inch interior area firing tray 70 is used, the network 84 can include 121 cylindrical apertures (11×11) forming the hollow recesses 86. Instead of including a separate insert 82, the network 84 of cylindrical apertures forming hollow recesses 86 can be integrally formed with or a part of the bottom wall 74 of the firing tray 70.

In FIG. 5, the firing tray 70 includes a number of dimples 88 that may be formed on, cast with, or otherwise attached to the bottom wall 74 to help keep the spark plug insulators aligned during a firing process. Alternatively, and as described above, the dimples 88 may be disposed on an insert that is placed in the firing tray 70. The dimples 88 are shown schematically on the bottom wall 74 of the firing tray 70, and it should be understood that more or less dimples may be included depending upon the time-temperature profiles for the firing process and/or the size of the firing tray. Similar to the hollow recesses 86, the dimples 88 may be sized to accommodate the spark plug insulators, and accordingly, the dimensions above with respect to the FIG. 4 embodiment may also apply to a firing tray including dimples 88.

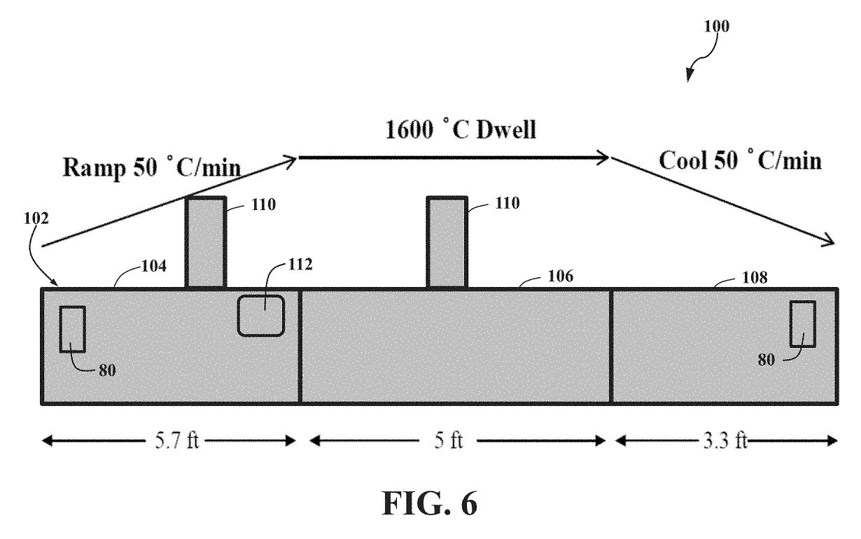

FIG. 6 shows a kiln 100 that may be used in some embodiments to carry out one or more steps of a spark plug microwave sintering process, such as process 200 that is described below with respect to FIG. 7. The kiln 100 in this particular embodiment is similar to a pusher plate type tunnel furnace, having a chamber 102 that is generally divided into three zones: a preheating zone 104, a sintering zone 106, and an exit zone 108. One or more firing trays, such as the firing tray 70, may be used to hold unfired spark plug insulators as they are introduced into the preheating zone 104 of the kiln 100. The firing trays may be moved horizontally through the kiln 100 at a fixed rate, and may slide on some type of rail system, rollers, belt, or other transportation mechanism. An actuator may be used to push the trays through the kiln 100, and during operation, if the kiln 100 is completely filled with firing trays, one tray may push on the next tray so that only one actuator is needed. The chamber 102 of kiln 100 may have an outer stainless steel, continuously seam welded shell, and may be lined with a high temperature fiber insulation (e.g., a combination of alumina and silica).

Kiln 100 provides a combination of microwave energy, via waveguide ports 110 for example, and radiant heat energy, from either susceptors 80, electric heating elements 112, and/or another radiant heat source. While the microwave power level may not be as finite and stepwise as if a batch type kiln were used, the microwave field intensity can be controlled via the number and baffling of the waveguide ports 110. The microwave waveguide ports 110 can penetrate the metal shell of the chamber 102 to input the microwave energy. However, it is desirable to seal the waveguide inputs 110 from the rest of the atmosphere or effluent from inside the kiln 100. In a preferred embodiment, microwave energy is applied through the roof of the kiln through two ports 110, one in the preheating zone 104 and one in the sintering zone 106. In some embodiments, various microwave choking systems and susceptors 80, or more particularly, silicon carbide absorbers, can be used in the preheating zone 104 and/or the exit zone 108 of the kiln 100 to help mitigate microwave leakage. Exhaust ports (not shown) can use an array of tube chokes where large diameter openings are desired. The particular time-temperature profiles and their relation to various microwave power levels will be discussed in greater detail with respect to the process 200.

Turning now to FIG. 7, there is shown a flowchart that illustrates an exemplary process 200 for microwave sintering a spark plug insulator, such as spark plug insulator 14. While described in conjunction with the kiln 100 of FIG. 6, skilled artisans will appreciate that different heating apparatuses other than kiln 100 may be used to carry out the process 200, and that any operable kiln or furnace design may be employed. Moreover, the particular time-temperature profiles and microwave power levels may be optimized for the desired spark plug insulator dimensions and/or ceramic composition. Furthermore, considerations such as kiln or zone length, belt speed, microwave power, and the particular type or structure of the microwave applicator may affect the firing process.

Step 202 of the method 200 involves loading an unfired spark plug insulator 14′ into a kiln, such as the kiln 100 shown in FIG. 6. The unfired spark plug insulator at least partially comprises ceramic material, and in a preferred embodiment, the ceramic material includes alumina ceramic particles. The unfired spark plug insulator 14′ is typically shaped as shown in FIG. 2 to include a nose portion 30′, an intermediate portion 32′, and a terminal portion 34′. In a preferred embodiment, a number of unfired spark plug insulators are placed into a firing tray 70 before being loaded into the kiln. Typically, the unfired spark plug insulators are placed in firing trays by a robot or pick and place machine. Preferably, the spark plug insulators are in a vertical orientation during the firing process 200 to avoid deformation from the force of gravity that may be likely at elevated temperatures. The firing tray 70 may be loaded into the kiln onto some type of rails or rollers and may be pushed through the furnace by an actuator or a subsequent tray.

Step 204 of the method involves heating the unfired spark plug insulator 14′ with radiant heat energy when the temperature of the unfired spark plug insulator is below a minimum absorption temperature. Below the minimum absorption temperature, the ceramic material is at least partially transparent to microwaves. Radiant heating allows the insulators to be heated to a temperature where they can more efficiently absorb microwave energy and be heated by the microwaves. Radiant heat energy may be provided in the preheating zone 104 of the kiln 100 through any operable source, such as through electric heating elements, microwave susceptors that are heated by microwaves and transmit heat to the insulators, or a combination of both, to cite a few examples. Accordingly, a combination of radiant heat energy and microwave energy is applied in the preheating zone 104, which helps sinter the insulators to a high density in a short amount of time. In a preferred embodiment, the heating rate is about 50° C. per minute. This step may also include a de-binding substep. In some embodiments, it may be desirable to heat the unfired spark plug insulator 14′ at a slower rate up to about 500° C. to remove organic processing aids such as organic binders which are used during the manufacture of the unfired insulators.

As addressed above, during step 204, radiant heat energy is preferably applied when the temperature of the unfired spark plug insulator is below the minimum absorption temperature where the ceramic material is at least partially transparent to microwaves. Skilled artisans will appreciate that the minimum absorption temperature may depend on a number of factors, including but not limited to the ceramic material composition, the frequency of the microwave energy being used, the desired firing time, and the dimensions of the kiln. For example, if the microwave frequency is 2.45 GHz, the minimum absorption temperature may be about 650° C. for a ceramic particle composition of 90 wt % alumina, about 850° C. for a ceramic particle composition of 96 wt % alumina, and about 900° C. for a ceramic particle composition of about 99 wt % alumina. In another example, if the microwave frequency is 915 MHz, the minimum absorption temperature may be about 560° C. for a ceramic particle composition of 90 wt % alumina, about 760° C. for a ceramic particle composition of 96 wt % alumina, and about 830° C. for a ceramic particle composition of about 99 wt % alumina. Accordingly, the minimum absorption temperature may be between about 560° C. and 900° C. Preferably, the minimum absorption temperature is 900° C. to ensure that the ceramic material can efficiently absorb microwave energy. Moreover, while 900° C. may be preferred in some embodiments, in other embodiments, the temperature can be adjusted based on the composition to have maximal heating accomplished by the microwave energy.

Step 206 of the method 200 involves heating the unfired spark plug insulator 14′ with microwave energy when the temperature of the unfired spark plug insulator is between the minimum absorption temperature and a maximum absorption temperature. As described above, microwave energy may be used in combination with radiant heat energy to heat the unfired spark plug insulator to the minimum absorption temperature, but it is preferable to use microwave energy for sintering once the minimum absorption temperature is reached and the unfired spark plug insulator is less transparent to microwaves. In some implementations, a combination of conventional radiant heat sources and microwave heating may be used when the temperature is between the minimum absorption temperature and the maximum absorption temperature. The maximum absorption temperature may be the temperature at which the slope of the loss tangent (tan δ) curve sharply increases (e.g., the slope increases by 50% or more). In one embodiment, the maximum absorption temperature is greater than about 1300° C. In one particular embodiment, the maximum absorption temperature is about 1450° C. At about 1450° C., a minimum half power depth of 2.8 cm was observed. The half power depth will also be discussed in detail below with regard to the dielectric property testing, but in brief, the half power depth of 2.8 cm at about 1450° C. indicates that a cross-section thickness of about 5.6 cm could be uniformly heated by microwave energy. More preferably, the maximum absorption temperature is about 1600° C., or it may be as high as about 1700° C. Once the unfired spark plug insulator 14′ reaches a temperature of about 1600° C. in the preheating zone 104, the sintering zone 106 may be maintained at a temperature of about 1600° C. until the spark plug insulator 14 is fully fired to a desired density. In one embodiment, the ramp time, or the time when the spark plug insulator is in the preheating zone 104, is about 32 minutes, and the dwell time, or the time when the spark plug insulator is in the sintering zone 106, is about 26 minutes.

The microwave power and frequency used in the method 200 depends upon a number of factors, such as dielectric property indicia including loss tangent (tan δ) and half power depth, which will be described in further detail below. In one embodiment, a power requirement of about 1136 W/kg or less is preferred. The total microwave power is about 33.8 kW when implementing a system such as kiln 100 and the mass of the spark plug insulators is approximately 39.8 kg in total being fired at one given time. In this implementation, it may be preferred to employ about 18.5 kW in the preheating zone 104 and about 15.3 kW in the sintering zone 106. The microwave frequency may be 915 MHz or 2.45 GHz, which are the most common industrial frequencies allowed for use by the Industrial Scientific and Medical (ISM) standard. Microwave equipment that operates at these frequencies is readily available and considerably more economical compared to equipment operating at other frequencies. Preferably, the microwave frequency is 2.45 GHz, however, other frequencies are possible, such as 5.8 GHz, 22 GHz, or 28 GHz, to cite a few examples. It has been estimated that a 30 kW, 2.45 GHz microwave generator will provide sufficient power. It is also possible to use two 15 kW, 2.45 microwave generators. Other power and frequency combinations are certainly possible, and as mentioned, will depend on factors such as the insulator composition, dielectric property indicia, and/or firing process parameters.

Step 208 involves obtaining a fired spark plug insulator 14 when the unfired spark plug insulator 14′ reaches the maximum absorption temperature. As described above, microwave energy is typically still applied once the spark plug insulator reaches the maximum absorption temperature in order to maintain the spark plug insulator at the maximum absorption temperature for a certain amount of time. The amount of time that the microwave energy is applied will typically depend upon the desired final density and other structural characteristics of the fired spark plug insulator 14. The ratio of the density of the unfired spark plug insulator to the density of fired spark plug insulator may range from about 1:1.65 to about 1:1.92. For 90 wt % alumina, the density of the fired spark plug insulator is preferably about 3.55 g/cc. For 96 wt % alumina, the density of the fired spark plug insulator is preferably about 3.75 g/cc. For 99 wt % alumina, the density of the fired spark plug insulator is preferably about 3.90 g/cc. Typically, the unfired spark plug insulator 14′ is off-white in color, whereas the fired spark plug insulator 14 is white in color.

Step 210 of the method 200 involves cooling the fired spark plug insulator 14 to a thermal shock avoidance temperature. Thermal shock can occur if an insulator is quenched in air from the maximum absorption temperature. Accordingly, it may be desirable to cool the fired spark plug insulator to the thermal shock avoidance temperature in the exit zone 108 of the kiln 100 before unloading the fired spark plug insulator from the kiln (step 212). In one particular embodiment, the thermal shock avoidance temperature is about 1000° C. Cooling the insulators to about 1000° C. over a period of a few minutes helps to avoid thermal shock. It has been shown that if the insulators are cooled too quickly, they can develop microcracks which reduce the mechanical and dielectric strength of the insulator. In one embodiment, the fired spark plugs 14 cool in the exit zone 108 of the kiln 100 for about 19 minutes. As described above, with a ramp time of about 32 minutes (heating at about 50° C. per minute), a dwell time of about 26 minutes, and a cool time of about 19 minutes, the total cycle time is about 77 minutes using kiln 100, which is about 14 feet in length. Using a firing tray 70 that holds 121 spark plug insulators, 30 insulators per minute may be produced using this exemplary time-temperature profile.

Step 212 of the method 200 involves unloading the fired spark plug insulator 14 from the kiln. Typically, as described above, the spark plug insulators are removed from the kiln 100 after reaching a thermal shock avoidance temperature so as to avoid microcracks and other undesirable defects that may impact the structural integrity or the dielectric properties of the insulator. This cooling may be accomplished in the kiln 100 itself, such as in exit zone 108, or in another insulated chamber or area. Once the fired spark plug insulator 14 is removed, it may require additional cooling. Also, the fired spark plug insulator 14 may be further shaped, worked, and/or otherwise formed using commonly known techniques like turning, grinding, cutting, sanding, polishing, buffing, etc. Decorating and glazing are the most common additional processing steps after bisque firing. Glazing and decorating require an additional firing step, which is in the range of 900° C. to 1100° C., well below the bisque firing temperature. The spark plug insulator 14 may then be inserted into a metal shell 16 and assembled into a completed spark plug 10.

In order to refine the time-temperature profiles and ensure the workability of microwave processing for alumina-based ceramic spark plug insulator compositions, dielectric testing was performed. The testing confirmed that certain alumina-based ceramic insulator compositions will directly absorb microwave energy and can benefit from microwave processing. As described above, at least some benefits include faster firing times and more uniform sintering. Dielectric properties were measured at microwave frequencies of 2.45 GHz and 915 MHz from room temperature to 1450° C. using a cavity perturbation method. The dielectric property measurements were performed in 50° C. steps to about 1450° C. A repeat measurement was obtained at about 1450° C., and then in 100° C. steps back down to room temperature. At the end of the cycle, the sample was removed and the empty holder was measured at room temperature, 600° C., 800° C., 1000° C., 1200° C., 1300° C., and 1450° C., for calibration. The sample was heated in a conventional furnace, and periodically dropped into a TM₀ₙ₀ resonant cavity (constant electric to magnetic field ratio), in which the perturbation of the field by the sample (i.e., the frequency shift and the quality factor shift) was captured using a network analyzer. The frequency shift corresponded to the real part of the permittivity (∈′), while the quality factor shift was used to determine the imaginary permittivity (∈″). Die-pressed pellets of differing lengths between 4 and 7 mm comprising various alumina compositions (90 wt %, 96 wt %, and 99 wt %) were analyzed. Three of the pellets were stacked in a 4 mm ID quartz sample holder to form the measurement sample. Certain dielectric property indicia were analyzed in the dielectric property testing. As understood by those skilled in the art, microwave heating occurs through dielectric loss mechanisms. Dielectric property indicia such as the loss tangent (tan δ) and the half power depth can provide a guide to microwave heating behavior for developing an optimal microwave sintering process. Table I below shows the physical properties of the samples before and after each cycle.

TABLE I

| | | | Stack | | Density |
|---|---|---|---|---|---|
| | | Diameter | Length | Mass | (g/cc) @ |
| Material | | (mm) | (mm) | (g) | RT |
| 90 wt % | Initial | 3.31 ± 0.05 | 13.42 ± 0.05 | 0.248 ± 0.002 | 2.15 ± 0.13 |
| alumina | Final | 2.98 ± 0.05 | 12.28 ± 0.05 | 0.239 ± 0.002 | 2.79 ± 0.16 |
| 96 wt % | Initial | 3.33 ± 0.05 | 14.21 ± 0.05 | 0.243 ± 0.002 | 1.96 ± 0.13 |
| alumina | Final | 2.91 ± 0.05 | 12.64 ± 0.05 | 0.235 ± 0.002 | 2.80 ± 0.16 |
| 99 wt % | Initial | 3.30 ± 0.05 | 11.9 ± 0.05 | 0.222 ± 0.002 | 2.16 ± 0.14 |
| alumina | Final | 3.01 ± 0.05 | 10.82 ± 0.05 | 0.215 ± 0.002 | 2.79 ± 0.16 |

The loss tangent (tan δ) is the dielectric loss (∈″) divided by the permittivity (∈′). Typically, when tan δ is less than 0.01, the material is fairly microwave transparent (i.e., the material weakly absorbs microwaves). Weak microwave absorption causes the material to remain cool, or to heat very slowly in a microwave field. A value of tan δ which is equal to or greater than 0.01 indicates that the material will absorb microwave energy and heat. The higher the value of tan δ is, the greater the microwave absorption will be, and the faster the material will heat up. If tan δ is greater than 2, the material can absorb microwave energy so well that the microwaves may not penetrate into the material very far, as indicated by the half power depth, which can lead to localized heating and “thermal runaway” which may be avoided through designed processing techniques.

The half power depth is the distance at which half of the microwave power is dissipated into the material. The half power depth is typically shorter at 2.45 GHz compared to 915 MHz due to the size of the wavelength. The wavelength at 915 MHz is approximately 3 times longer compared to 2.45 GHz, which increases the depth that the microwave energy can penetrate into a material. The equation below may be used to calculate the half power depth:

$${D}_{HP} = \frac{c ( ln 2 )}{2 {ωɛ}_{0}} {( \frac{2}{( \sqrt{1 + {( tan δ )}^{2}} - 1 ) {ɛ}^{′}} )}^{\frac{1}{2}}$$

where D_{HP} is the half power depth, c is the speed of light, ω is the angular frequency, ∈₀ is the permittivity of free space, tan δ is the loss tangent, and ∈′ is the permittivity. tan δ and half power depth typically have an inverse relationship, and accordingly, with a higher tan δ there is a smaller half power depth. A higher tan δ indicates better absorption of microwave energy, which means that the energy is absorbed by the material over a shorter distance. The half power depth can be used to estimate the material thickness which will receive uniform microwave energy which will receive uniform microwave energy. For example, a half power depth of 10 mm indicates that a sample with a minimum dimension of 20 mm (e.g., a 20 mm thick part) would receive a uniform amount of microwave power. Microwave energy penetrates samples from all sides, so the smallest sample dimension is considered more important when looking at uniform power application. In the case where the sample thickness is more than twice the half power depth, the interior of the sample may receive a lower level of microwave energy compared to the exterior. Even in the case where the half power depth is less than half the sample thickness, microwave heating can still be beneficial, however.

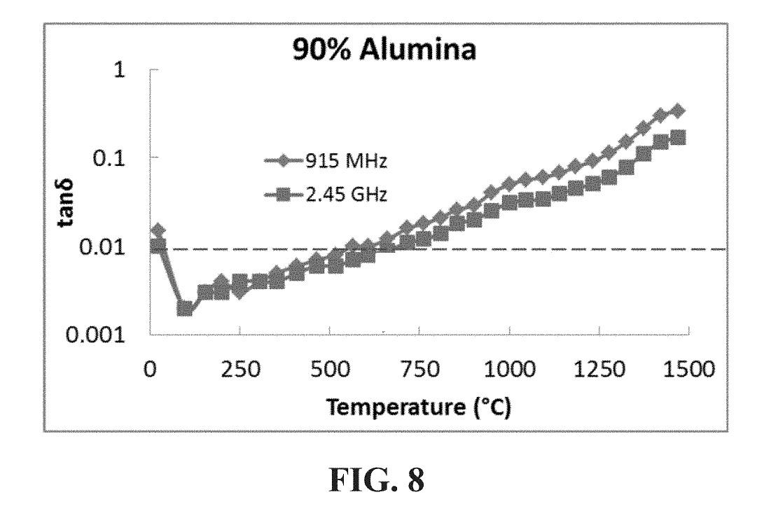

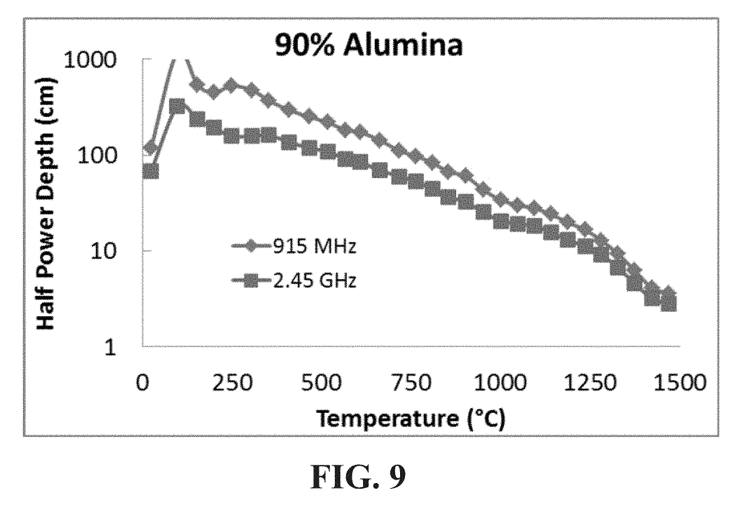

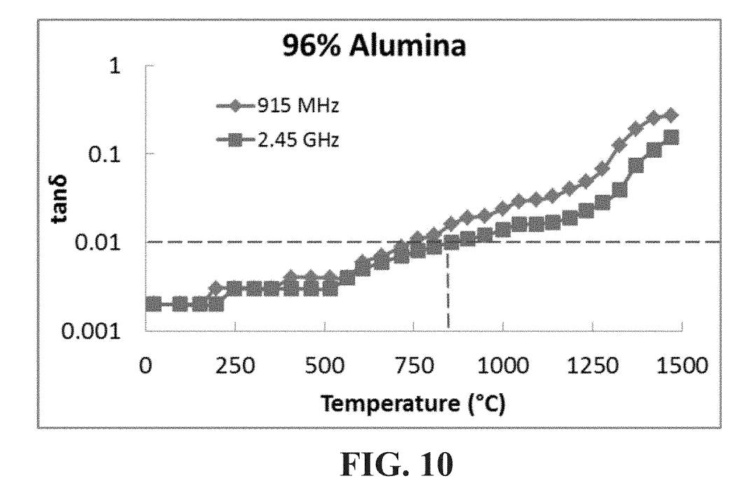

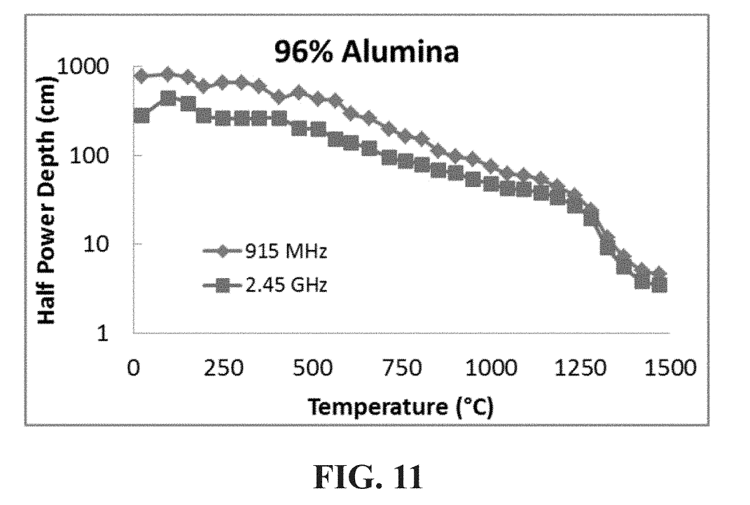

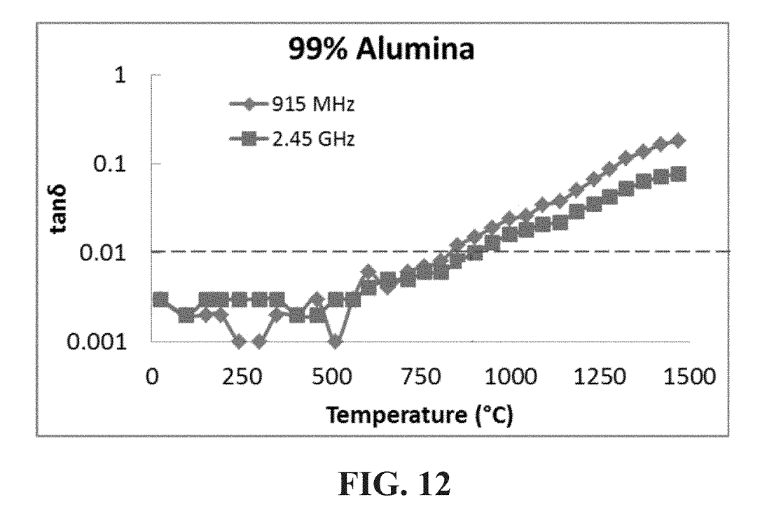

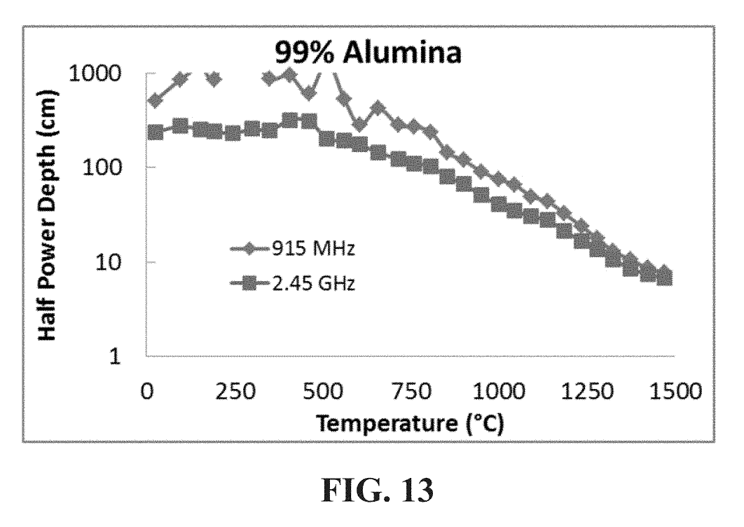

The results of the dielectric property testing are shown in FIGS. 8-13. As described above, each test was performed at 2.45 GHz and 915 MHz microwave frequencies. FIGS. 8 and 9 show tan δ and half power depth, respectively, for the 90 wt % alumina-based ceramic compositions. FIGS. 10 and 11 show tan δ and half power depth, respectively, for the 96 wt % alumina-based ceramic compositions. FIGS. 12 and 13 show tan δ and half power depth, respectively, for the 99 wt % alumina-based ceramic compositions. Overall, the results indicate that these materials should absorb microwave energy from at least 700° C. to greater than 1450° C., as the tan δ value is above 0.01 for each composition in this temperature region. There is a sharp increase in each tan δ curve starting around 1300° C., which indicates strong microwave heating in this region, especially for the 90 wt % and 96 wt % alumina compositions. The low values of tan δ at less than 700° C. indicate that the materials are fairly transparent in this temperature region. The dielectric data shows that all three compositions should heat fairly well in the higher temperature range, with the two lower purity alumina compositions heating better than the 99 wt % alumina. The dielectric property results indicate that it is possible to fire the 90 wt % and 96 wt % alumina-based compositions together in the same kiln, as their tan δ values appear similar. Firing the 99 wt % separately may be desirable, as this composition could be under-fired if fired with lower purity alumina-based compositions.

FIGS. 8 and 9 show tan δ and half power depth, respectively, for the 90 wt % alumina-based ceramic compositions. For 2.45 GHz, the transparent temperature range is about 100° C. to about 650° C., the coupling temperature range is about 650° C. to greater than 1450° C., and the minimum half power depth is about 2.8 cm. For 915 MHz, the transparent temperature range is about 100° C. to about 560° C., the coupling temperature range is about 560° C. to greater than 1450° C., and the minimum half power depth is about 3.6 cm. It should be noted that in FIG. 9, the 915 MHz data has been cut off above 1000 cm.

FIGS. 10 and 11 show tan δ and half power depth, respectively, for the 96 wt % alumina-based ceramic compositions. For 2.45 GHz, the transparent temperature range is about 25° C. to about 850° C., the coupling temperature range is about 850° C. to greater than 1450° C., and the minimum half power depth is about 3.5 cm. For 915 MHz, the transparent temperature range is about 100° C. to about 760° C., the coupling temperature range is about 760° C. to greater than 1450° C., and the minimum half power depth is about 4.7 cm.

FIGS. 12 and 13 show tan δ and half power depth, respectively, for the 99 wt % alumina-based ceramic compositions. For 2.45 GHz, the transparent temperature range is about 100° C. to about 900° C., the coupling temperature range is about 900° C. to greater than 1450° C., and the minimum half power depth is about 6.8 cm. For 915 MHz, the transparent temperature range is about 100° C. to about 830° C., the coupling temperature range is about 830° C. to greater than 1450° C., and the minimum half power depth is about 7.8 cm. It should be noted that in FIG. 13, the 915 MHz data has been cut off above 1000 cm.

As shown and described above, both microwave frequencies that were tested (915 MHz and 2.45 GHz) appear to be viable options for heating alumina-based spark plug insulator compositions. Comparing the dielectric data for the two microwave frequencies, 915 MHz had slight higher values of tan δ compared to 2.45 GHz, and also a longer half power depth. This indicates that direct microwave coupling or heating will start at approximately 100° C. lower for 915 MHz as compared to 2.45 GHz and have a slightly longer penetration depth, which could offer a processing advantage. The heating characteristics at 2.45 GHz also fall within an acceptable data range for adequate microwave heating and susceptability. Typically, 2.45 GHz is used for smaller, lab-scale, and low power kilns, while 915 MHz is used as power demands (e.g., greater than 30 kW) and cavity size increases. The option to use either frequency enables design flexibility for the microwave kiln.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A method of manufacturing a spark plug, comprising the steps of:
loading an unfired spark plug insulator into a kiln, wherein the unfired spark plug insulator has a density and at least partially comprises a ceramic material;
heating the unfired spark plug insulator with radiant heat energy when the temperature of the unfired spark plug insulator is below a minimum absorption temperature, wherein the ceramic material is at least partially transparent to microwave energy at the minimum absorption temperature;
heating the unfired spark plug insulator with microwave energy until the temperature of the unfired spark plug insulator reaches a maximum absorption temperature, wherein the unfired spark plug insulator becomes a fired spark plug insulator upon reaching the maximum absorption temperature, wherein the fired spark plug insulator has a density; and
unloading the fired spark plug insulator from the kiln, wherein the density of the fired spark plug insulator is higher than the density of the unfired spark plug insulator.

2. The method as defined in claim 1, further comprising the step of:
cooling the fired spark plug insulator in a thermally controlled environment until the temperature of the fired spark plug insulator reaches a thermal shock avoidance temperature.

3. The method as defined in claim 2, wherein the minimum absorption temperature is in a range from 560° C. to 900° C., inclusive, the maximum absorption temperature is in a range from 1300° C. to 1700° C., inclusive, and the thermal shock avoidance temperature is 1000° C.

4. The method as defined in claim 2, wherein the kiln includes a pre-heating zone for heating the unfired spark plug insulator with radiant heat energy, a sintering zone for heating the unfired spark plug insulator with microwave energy, and an exit zone for cooling the fired spark plug insulator.

5. The method as defined in claim 4, wherein the kiln includes a susceptor in the pre-heating zone for absorbing microwave energy and providing radiant heat energy.

6. The method as defined in claim 1, further comprising the step of inserting the fired spark plug insulator into a metallic shell having an internal bore, wherein an intermediate portion of the fired spark plug insulator is at least partially housed within the internal bore of the metallic shell.

7. The method as defined in claim 1, wherein the ceramic material of the unfired spark plug insulator comprises 90 wt % alumina, the density of the unfired spark plug insulator is in a range of 2.02 g/cc to 2.28 g/cc, inclusive, and the density of the fired spark plug insulator is in a range of 2.63 g/cc to 3.55 g/cc, inclusive.

8. The method as defined in claim 1, wherein the ceramic material of the unfired spark plug insulator comprises 96 wt % alumina, the density of the unfired spark plug insulator is in a range of 1.83 g/cc to 2.09 g/cc, inclusive, and the density of the fired spark plug insulator is in a range of 2.64 g/cc to 3.75 g/cc, inclusive.

9. The method as defined in claim 1, wherein the ceramic material of the unfired spark plug insulator comprises 99 wt % alumina, the density of the unfired spark plug insulator is in a range of 2.02 g/cc to 2.30 g/cc, inclusive, and the density of the fired spark plug insulator is in a range of 2.63 g/cc to 3.9 g/cc.

10. The method as defined in claim 1, wherein the step of heating the unfired spark plug insulator with radiant heat energy includes heating the unfired spark plug insulator at a heating rate of about 50° C. per minute.

11. The method as defined in claim 1, wherein the microwave energy has a frequency of about 2.45 GHz and the minimum absorption temperature is about 650° C.

12. The method as defined in claim 1, wherein the microwave energy has a frequency of about 915 MHz and the minimum absorption temperature is about 560° C.

13. A method of manufacturing a spark plug, comprising the steps of:
loading an unfired spark plug insulator into a kiln, wherein the unfired spark plug insulator comprises a ceramic material that is at least partially transparent to microwave energy, and the kiln comprises a pre-heating zone, a sintering zone, and an exit zone;
heating the unfired spark plug insulator with radiant heat energy in the pre-heating zone of the kiln;
moving the unfired spark plug insulator to the sintering zone of the kiln;
heating the unfired spark plug insulator with microwave energy in the sintering zone of the kiln until the unfired spark plug insulator becomes a fired spark plug insulator, wherein the unfired spark plug insulator has a density and the fired spark plug insulator has a density, and a ratio of the density of the unfired spark plug insulator to the density of the fired spark plug insulator is in a range of about 1:1.65 to about 1:1.92, inclusive;
cooling the fired spark plug insulator in the exit zone of the kiln; and
unloading the fired spark plug insulator from the kiln.

14. A spark plug insulator firing tray, comprising:
an exterior housing having a bottom wall and a side wall, wherein the exterior housing is at least partially transparent to microwaves and is comprised of a low mass refractory material that is coated with a layer of ceramic material, wherein the layer of ceramic material is denser than the low mass refractory material; and
a spark plug insulator support, wherein the spark plug insulator support is configured to maintain at least one spark plug insulator in a vertical position during a spark plug insulator firing process.

15. The spark plug insulator firing tray as defined in claim 14, wherein the spark plug insulator support is an insert placed within the exterior housing, wherein the insert is comprised of a susceptor material.

16. The spark plug insulator firing tray as defined in claim 14, wherein the low mass refractory material comprises mullite.

17. The spark plug insulator firing tray as defined in claim 14, wherein the layer of ceramic material that coats the low mass refractory material comprises mullite.

18. The spark plug insulator firing tray as defined in claim 14, wherein the spark plug insulator support comprises an integrally cast dimple pattern in the bottom wall of the exterior housing.

19. The spark plug insulator firing tray as defined in claim 14, wherein the spark plug insulator support comprises a network of hollow recesses.

20. The spark plug insulator firing tray as defined in claim 14, further comprising a susceptor for absorbing microwave energy and providing radiant heat energy.
